(19) United States
(12) Patent Application Publication
(10) Pub. No.: US 2023/0313771 A1
(43) Pub. Date: Oct. 5, 2023

(54) PRECISION VALVE FOR VEHICLE

(71) Applicant: GM GLOBAL TECHNOLOGY OPERATIONS LLC, Detroit, MI (US)

(72) Inventors: Chandra S. NAMUDURI, Troy, MI (US); Thomas W. Nehl, Shelby Township, MI (US); Avoki M. Omekanda, Rochester, MI (US); Suresh Gopalakrishnan, Troy, MI (US)

(21) Appl. No.: 17/708,125

(22) Filed: Mar. 30, 2022

(51) Int. Cl. F02M 61/06; F02M 51/06; F02M 57/00; F02M 61/16; F02M 61/18

(52) U.S. Cl. CPC F02M 61/06; F02M 51/0664; F02M 57/005; F02M 61/166; F02M 61/188; F02M 61/168; F02M 2200/24; F02M 2200/8084; F02M 2200/9053

(57) ABSTRACT

A valve system of a vehicle includes: a housing that is electrically conductive and made of a metal and that includes: an inlet configured to receive a fluid; an outlet configured to output the fluid; and a fluid channel fluidly connecting the inlet and the outlet; a pintle disposed within the housing and that is electrically conductive and made of a metal; a ball that is mechanically fastened to the pintle, that is configured to close the outlet, and that is electrically conductive and made of a metal; an armature that is mechanically fastened to the pintle, that is disposed within the housing, and that is electrically conductive and made of a metal; a solenoid coil that is disposed within the housing and that surrounds the pintle; and an electrically insulative material configured to insulate the pintle from the housing.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicles and more particularly to valves, such as fuel injectors.

Some types of vehicles include only an internal combustion engine that generates propulsion torque. Hybrid vehicles include both an internal combustion engine and one or more electric motors. Some types of hybrid vehicles utilize the electric motor and the internal combustion engine to improve fuel efficiency. Other types of hybrid vehicles utilize the electric motor and the internal combustion engine to achieve greater torque output.

Examples of hybrid vehicles include parallel hybrid vehicles, series hybrid vehicles, and other types of hybrid vehicles. In a parallel hybrid vehicle, the electric motor works in parallel with the engine to combine power and range advantages of the engine with efficiency and regenerative braking advantages of electric motors. In a series hybrid vehicle, the engine drives a generator to produce electricity for the electric motor, and the electric motor drives a transmission. This allows the electric motor to assume some of the power responsibilities of the engine, which may permit the use of a smaller and possibly more efficient engine. The present application is applicable to electric vehicles, hybrid vehicles, and other types of vehicles.

### SUMMARY

In a feature, a valve system of a vehicle includes: a housing that is electrically conductive and made of a metal and that includes: an inlet configured to receive a fluid; an outlet configured to output the fluid; and a fluid channel fluidly connecting the inlet and the outlet; a pintle disposed within the housing and that is electrically conductive and made of a metal; a ball that is mechanically fastened to the pintle, that is configured to close the outlet, and that is electrically conductive and made of a metal; an armature that is mechanically fastened to the pintle, that is disposed within the housing, and that is electrically conductive and made of a metal; a solenoid coil that is disposed within the housing and that surrounds the pintle; and an electrically insulative material configured to insulate the pintle from the housing.

In further features, the valve system further includes: a first electrical conductor that is electrically connected to a flux ring; and a second electrical conductor that is electrically connected to the housing.

In further features, the valve system further includes the flux ring, where the flux ring is electrically conductive and made of a metal.

In further features, the electrically insulative material is disposed on an outer diameter of the flux ring.

In further features, the valve system further includes a sensor that is electrically connected to the first and second electrical conductors.

In further features, the sensor is configured to measure a voltage across the first and second electrical conductors.

In further features, the sensor is configured to measure a resistance between the pintle and the housing.

In further features, the electrically insulative material is disposed on an outer portion of the ball.

In further features, the electrically insulative material is disposed a predetermined distance above and below an equator of the ball.

In further features, the electrically insulative material is disposed on an outer diameter of the armature.

In further features, the valve system further includes a guide ring that is disposed radially outwardly of the armature.

In further features, the electrically insulative material is disposed on an inner diameter of a guide ring that is disposed radially outwardly of the armature.

In further features, the valve system further includes the guide ring.

In further features, the valve system further includes a weld ring that is electrically insulative and that is disposed radially outwardly of the guide ring.

In further features: the housing includes a first housing portion and a second housing portion; and the weld ring is disposed vertically between the first housing portion and the second housing portion.

In further features, the valve system further includes: a first brazed joint where the first housing portion contacts the weld ring; and a second brazed joint where the second housing portion contacts the weld ring.

In further features, the valve system is a fuel injector system and the outlet is configured to extend into an engine of the vehicle.

In further features, the outlet extends into a cylinder of the engine.

In further features, the metal is a stainless steel.

In further features, the electrically insulative material includes one of diamond, a polymer, a nanomaterial, a ceramic, and a composite material.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example engine control system;

FIG. 2 is a functional block diagram of an example implementation of a fuel control system;

FIG. 3 includes a functional block diagram of an example portion of an engine control module;

FIG. 4 is a cross-sectional view of an example implementation of a fuel injector;

FIG. 5 is a cross-sectional view of a top portion of the fuel injector;

FIGS. 6 and 7 are cross-sectional views of a middle portion of the fuel injector;

FIG. 8 is a cross-sectional view of a bottom portion of the fuel injector; and

FIG. 9 is an example graph of current compensation based on an opening delay of the fuel injector measured using the sensor and a closing delay of the fuel injector measured using the sensor.

In the drawings, reference numbers may be reused to identify similar and/or identical elements.

### DETAILED DESCRIPTION

Fuel injectors of vehicles include electrically conductive metal housings. Metal might be used, for example, to withstand the temperature and pressure conditions of an engine. The fuel injectors include electrically conductive metal valve stems (including a pintle and an armature) that are actuated by a solenoid coil. Magnetic flux generated by the solenoid coil when power is applied to the solenoid coil moves the valve stem and opens the fuel injector. The fuel injector closes when power is disconnected from solenoid coil.

Opening and closing of the fuel injector can be indirectly determined, such as based on residual voltage and/or fuel rail pressure. However, extensive signal processing may be involved and noise may decrease accuracy. Additionally, accuracy may be decreased for situations where multiple fuel injections are performed within a short period.

The present application involves electrically isolating the valve stem from the housing, such as by including electrically insulative material on at least one of a ball of the pintle, an outer diameter of an armature, an inner diameter of a guide ring, and an outer diameter of a flux ring. Electrical conductors are connected to the housing and the flux ring, and a sensor measures a voltage across the electrical conductors. The sensor directly measures opening and closing of the fuel injector via the electrical conductors. The direct measurement of opening and closing of the fuel injector increases accuracy of fuel injection amount and timing to target amounts and timings.

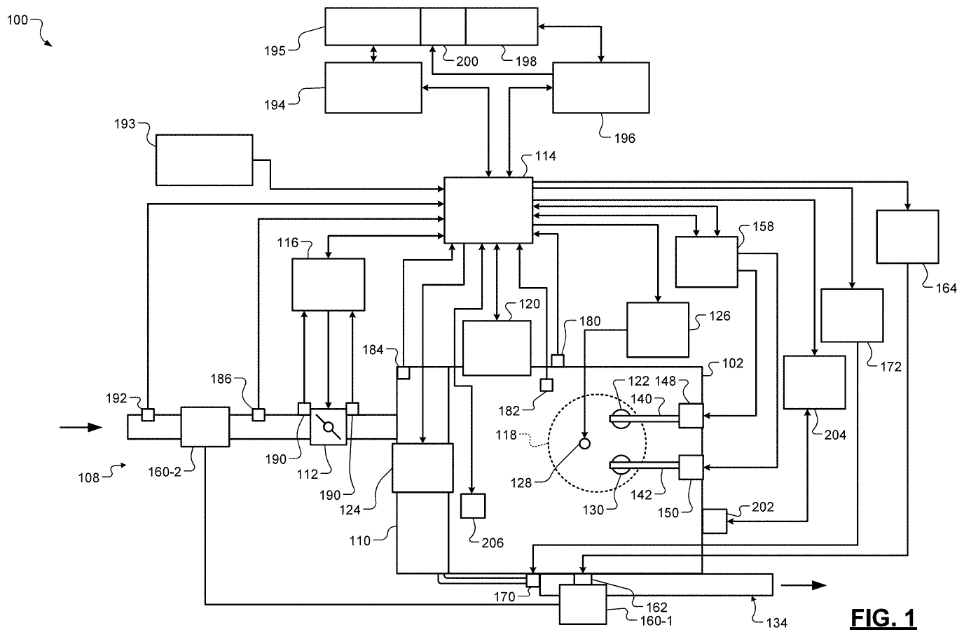

Referring now to FIG. 1, a functional block diagram of an example powertrain system 100 is presented. The powertrain system 100 of a vehicle includes an engine 102 that combusts an air/fuel mixture to produce torque. The vehicle may be non-autonomous or autonomous.

Air is drawn into the engine 102 through an intake system 108. The intake system 108 may include an intake manifold 110 and a throttle valve 112. For example only, the throttle valve 112 may include a butterfly valve having a rotatable blade. An engine control module (ECM) 114 controls a throttle actuator module 116, and the throttle actuator module 116 regulates opening of the throttle valve 112 to control airflow into the intake manifold 110.

Air from the intake manifold 110 is drawn into cylinders of the engine 102. While the engine 102 includes multiple cylinders, for illustration purposes a single representative cylinder 118 is shown. For example only, the engine 102 may include 2, 3, 4, 5, 6, 8, 10, and/or 12 cylinders. The ECM 114 may instruct a cylinder actuator module 120 to selectively deactivate some of the cylinders under some circumstances, which may improve fuel efficiency.

The engine 102 may operate using a four-stroke cycle or another suitable engine cycle. The four strokes of a four-stroke cycle, described below, will be referred to as the intake stroke, the compression stroke, the combustion stroke, and the exhaust stroke. During each revolution of a crankshaft (not shown), two of the four strokes occur within the cylinder 118. Therefore, two crankshaft revolutions are necessary for the cylinder 118 to experience all four of the strokes. For four-stroke engines, one engine cycle may correspond to two crankshaft revolutions.

When the cylinder 118 is activated, air from the intake manifold 110 is drawn into the cylinder 118 through an intake valve 122 during the intake stroke. The ECM 114 controls a fuel actuator module 124, which regulates fuel injection to achieve a desired air/fuel ratio. Fuel may be injected into the intake manifold 110 at a central location or at multiple locations, such as near the intake valve 122 of each of the cylinders. In various implementations (not shown), fuel may be injected directly into the cylinders or into mixing chambers/ports associated with the cylinders. The fuel actuator module 124 may halt injection of fuel to cylinders that are deactivated.

The injected fuel mixes with air and creates an air/fuel mixture in the cylinder 118. During the compression stroke, a piston (not shown) within the cylinder 118 compresses the air/fuel mixture. The engine 102 may be a compression-ignition engine, in which case compression causes ignition of the air/fuel mixture. Alternatively, the engine 102 may be a spark-ignition engine, in which case a spark actuator module 126 energizes a spark plug 128 in the cylinder 118 based on a signal from the ECM 114, which ignites the air/fuel mixture. Some types of engines, such as homogenous charge compression ignition (HCCI) engines may perform both compression ignition and spark ignition. The timing of the spark may be specified relative to the time when the piston is at its topmost position, which will be referred to as top dead center (TDC).

The spark actuator module 126 may be controlled by a timing signal specifying how far before or after TDC to generate the spark. Because piston position is directly related to crankshaft rotation, operation of the spark actuator module 126 may be synchronized with the position of the crankshaft. The spark actuator module 126 may disable provision of spark to deactivated cylinders or provide spark to deactivated cylinders.

During the combustion stroke, the combustion of the air/fuel mixture drives the piston down, thereby driving the crankshaft. The combustion stroke may be defined as the time between the piston reaching TDC and the time when the piston returns to a bottom most position, which will be referred to as bottom dead center (BDC).

During the exhaust stroke, the piston begins moving up from BDC and expels the byproducts of combustion through an exhaust valve 130. The byproducts of combustion are exhausted from the vehicle via an exhaust system 134.

The intake valve 122 may be controlled by an intake camshaft 140, while the exhaust valve 130 may be controlled by an exhaust camshaft 142. In various implementations, multiple intake camshafts (including the intake camshaft 140) may control multiple intake valves (including the intake valve 122) for the cylinder 118 and/or may control the intake valves (including the intake valve 122) of multiple banks of cylinders (including the cylinder 118). Similarly, multiple exhaust camshafts (including the exhaust camshaft 142) may control multiple exhaust valves for the cylinder 118 and/or may control exhaust valves (including the exhaust valve 130) for multiple banks of cylinders (including the cylinder 118). While camshaft-based valve actuation is shown and has been discussed, camless valve actuators may be implemented. While separate intake and exhaust camshafts are shown, one camshaft having lobes for both the intake and exhaust valves may be used.

The cylinder actuator module 120 may deactivate the cylinder 118 by disabling opening of the intake valve 122 and/or the exhaust valve 130. The time when the intake valve 122 is opened may be varied with respect to piston TDC by an intake cam phaser 148. The time when the exhaust valve 130 is opened may be varied with respect to piston TDC by an exhaust cam phaser 150. A phaser actuator module 158 may control the intake cam phaser 148 and the exhaust cam phaser 150 based on signals from the ECM 114. In various implementations, cam phasing may be omitted. Variable valve lift (not shown) may also be controlled by the phaser actuator module 158. In various other implementations, the intake valve 122 and/or the exhaust valve 130 may be controlled by actuators other than a camshaft, such as electromechanical actuators, electrohydraulic actuators, electromagnetic actuators, etc.

The engine 102 may include zero, one, or more than one boost device that provides pressurized air to the intake manifold 110. For example, FIG. 1 shows a turbocharger including a turbocharger turbine 160-1 that is driven by exhaust gases flowing through the exhaust system 134. A supercharger is another type of boost device.

The turbocharger also includes a turbocharger compressor 160-2 that is driven by the turbocharger turbine 160-1 and that compresses air leading into the throttle valve 112. A wastegate (WG) 162 controls exhaust flow through and bypassing the turbocharger turbine 160-1. Wastegates can also be referred to as (turbocharger) turbine bypass valves. The wastegate 162 may allow exhaust to bypass the turbocharger turbine 160-1 to reduce intake air compression provided by the turbocharger. The ECM 114 may control the turbocharger via a wastegate actuator module 164. The wastegate actuator module 164 may modulate the boost of the turbocharger by controlling an opening of the wastegate 162.

A cooler (e.g., a charge air cooler or an intercooler) may dissipate some of the heat contained in the compressed air charge, which may be generated as the air is compressed. Although shown separated for purposes of illustration, the turbocharger turbine 160-1 and the turbocharger compressor 160-2 may be mechanically linked to each other, placing intake air in close proximity to hot exhaust. The compressed air charge may absorb heat from components of the exhaust system 134.

The engine 102 may include an exhaust gas recirculation (EGR) valve 170, which selectively redirects exhaust gas back to the intake manifold 110. The EGR valve 170 may receive exhaust gas from upstream of the turbocharger turbine 160-1 in the exhaust system 134. The EGR valve 170 may be controlled by an EGR actuator module 172.

Crankshaft position may be measured using a crankshaft position sensor 180. An engine speed may be determined based on the crankshaft position measured using the crankshaft position sensor 180. A temperature of engine coolant may be measured using an engine coolant temperature (ECT) sensor 182. The ECT sensor 182 may be located within the engine 102 or at other locations where the coolant is circulated, such as a radiator (not shown).

A pressure within the intake manifold 110 may be measured using a manifold absolute pressure (MAP) sensor 184. In various implementations, engine vacuum, which is the difference between ambient air pressure and the pressure within the intake manifold 110, may be measured. A mass flow rate of air flowing into the intake manifold 110 may be measured using a mass air flow (MAF) sensor 186. In various implementations, the MAF sensor 186 may be located in a housing that also includes the throttle valve 112.

Position of the throttle valve 112 may be measured using one or more throttle position sensors (TPS) 190. A temperature of air being drawn into the engine 102 may be measured using an intake air temperature (IAT) sensor 192. One or more other sensors 193 may also be implemented. The other sensors 193 include an accelerator pedal position (APP) sensor, a brake pedal position (BPP) sensor, may include a clutch pedal position (CPP) sensor (e.g., in the case of a manual transmission), and may include one or more other types of sensors. An APP sensor measures a position of an accelerator pedal within a passenger cabin of the vehicle. A BPP sensor measures a position of a brake pedal within a passenger cabin of the vehicle. A CPP sensor measures a position of a clutch pedal within the passenger cabin of the vehicle. The other sensors 193 may also include one or more acceleration sensors that measure longitudinal (e.g., fore/aft) acceleration of the vehicle and latitudinal acceleration of the vehicle. An accelerometer is an example type of acceleration sensor, although other types of acceleration sensors may be used. The ECM 114 may use signals from the sensors to make control decisions for the engine 102.

The ECM 114 may communicate with a transmission control module 194, for example, to coordinate engine operation with gear shifts in a transmission 195. The ECM 114 may communicate with a hybrid control module 196, for example, to coordinate operation of the engine 102 and an electric motor 198 (electric machine). While the example of one electric motor is provided, multiple electric motors may be implemented. The electric motor 198 may be a permanent magnet electric motor or another suitable type of electric motor that outputs voltage based on back electromagnetic force (EMF) when free spinning, such as a direct current (DC) electric motor or a synchronous electric motor. In various implementations, various functions of the ECM 114, the transmission control module 194, and the hybrid control module 196 may be integrated into one or more modules.

Each system that varies an engine parameter may be referred to as an engine actuator. Each engine actuator has an associated actuator value. For example, the throttle actuator module 116 may be referred to as an engine actuator, and the throttle opening area may be referred to as the actuator value. In the example of FIG. 1, the throttle actuator module 116 achieves the throttle opening area by adjusting an angle of the blade of the throttle valve 112.

The spark actuator module 126 may also be referred to as an engine actuator, while the corresponding actuator value may be the amount of spark advance relative to cylinder TDC. Other engine actuators may include the cylinder actuator module 120, the fuel actuator module 124, the phaser actuator module 158, the wastegate actuator module 164, and the EGR actuator module 172. For these engine actuators, the actuator values may correspond to a cylinder activation/deactivation sequence, fueling rate, intake and exhaust cam phaser angles, target wastegate opening, and EGR valve opening, respectively.

The ECM 114 may control the actuator values in order to cause the engine 102 to output torque based on a torque request. The ECM 114 may determine the torque request, for example, based on one or more driver inputs, such as an APP, a BPP, a CPP, and/or one or more other suitable driver inputs. The ECM 114 may determine the torque request, for example, using one or more functions or lookup tables that relate the driver input(s) to torque requests.

Under some circumstances, the hybrid control module 196 controls the electric motor 198 to output torque, for example, to supplement engine torque output. The hybrid control module 196 may also control the electric motor 198 to output torque for vehicle propulsion at times when the engine 102 is shut down.

The hybrid control module 196 applies electrical power from a battery to the electric motor 198 to cause the electric motor 198 to output positive torque. The electric motor 198 may output torque, for example, to an input shaft of the transmission 195, to an output shaft of the transmission 195, or to another component. A clutch 200 may be implemented to couple the electric motor 198 to the transmission 195 and to decouple the electric motor 198 from the transmission 195. One or more gearing devices may be implemented between an output of the electric motor 198 and an input of the transmission 195 to provide one or more predetermined gear ratios between rotation of the electric motor 198 and rotation of the input of the transmission 195. In various implementations, the electric motor 198 may be omitted. The present application is also applicable to the inclusion of multiple electric motors.

Fuel injectors may have continuous metallic (and electrically conductive) interfaces between their fuel outlet ports and the valve stems. Due to their electrical conductivity, opening and closing of the fuel injectors may not be directly measured. For example, fuel rail pressure or residual voltage may be used to determine opening and closing of the fuel injectors. These methods, however, are susceptible to noise and may involve extensive signal processing yet still may not yield reliable information on opening and closing for closely spaced small fuel injections, such as may be used with direct injection engines.

As discussed further below, the fuel injectors of the present disclosure include electrical insulators such that open time of the fuel injectors can be directly measured. The ECM 114 may adjust the application of power to the fuel injectors based on the measured open time to adjust the actual amount of fuel injected toward or to a commanded fuel injection amount. While the example of fuel injectors is provided, the present application is also applicable to measuring open time of other types of valves.

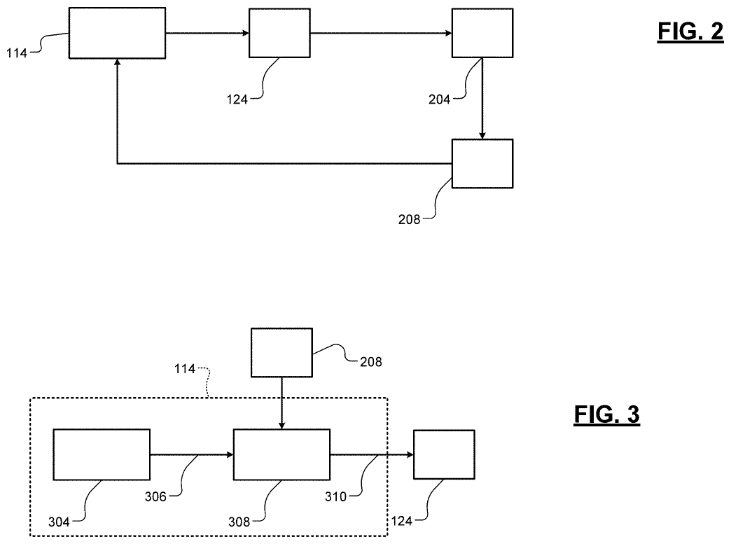

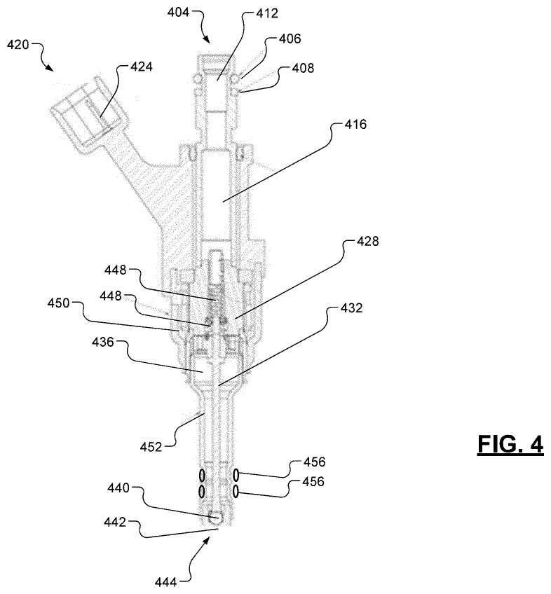

FIG. 2 is a functional block diagram of an example implementation of a fuel control system. As discussed above, the ECM 114 controls fuel injection by the fuel injectors, such as fuel injector 204. FIG. 3 includes a functional block diagram of an example portion of the ECM 114.

A fuel mass module 304 may include a fuel injection amount (e.g., mass) 306 for an injection by the fuel injector 204. The fuel mass module 304 may determine the fuel injection amount 306, for example, based on an amount of air within a cylinder fueled by the fuel injector, such as based on achieving a target air/fuel ratio or a target equivalence ratio. The fuel mass module 304 may determine the fuel injection amount 306, for example, using an equation or a lookup table.

A current control module 308 determines a current command 310 for the fuel injection based on the fuel injection amount. The current command 310 may include a current profile over time to apply to the fuel injector 204 for the fuel injection event. The current control module 308 may determine the current command 310, for example, using an equation or a lookup table that relates fuel injection amounts to current commands. The fuel actuator module 124 applies power to the fuel injector 204 (e.g., from a battery) based on the current command 310. The fuel actuator module 124 may be, for example, a solenoid driver. The fuel actuator module 124 may apply pulse width modulation (PWM) signals to the fuel injector 204.

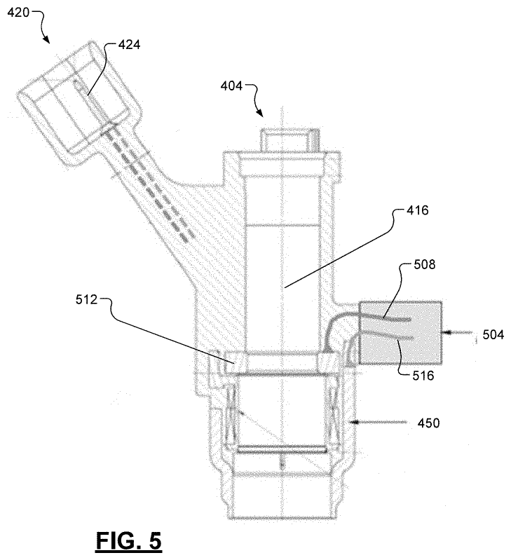

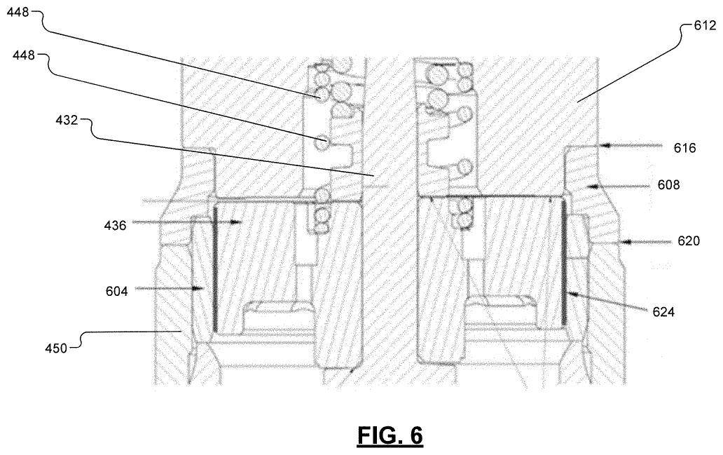

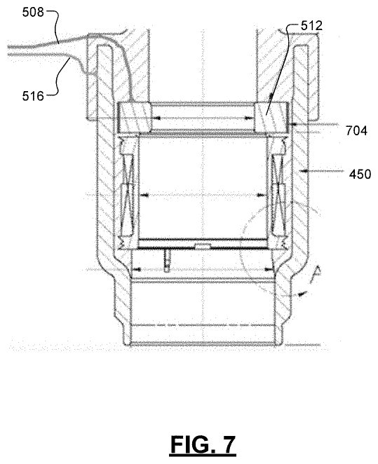

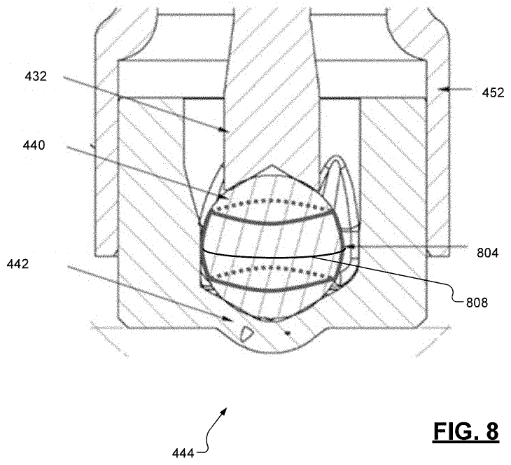

FIG. 4 is a cross-sectional view of an example implementation of the fuel injector 204. FIG. 5 is a cross-sectional view of a top portion of the fuel injector 204. FIGS. 6 and 7 are cross-sectional views of a middle portion of the fuel injector 204. FIG. 8 is a cross-sectional view of a bottom portion of the fuel injector 204.

The fuel injector 204 includes a fuel inlet 404 where the fuel injector 204 receives fuel from a fuel rail. O-rings 406 and 408 may be included and provide seals between the fuel injector 204 and the fuel rail. In various implementations, a filter 412 may be implemented to filter received fuel. The fuel inlet 404 is fluidly connected to a fuel channel 416.

The fuel actuator module 124 is electrically connected to the fuel injector 204 via a connector 420. Connector pins, such as 424, are electrically connected to a solenoid coil 428 that encircles a pintle 432. The pintle 432 is made of an electrically conductive material, such as steel. An armature 436 is coupled to the pintle 432. The armature 436 is made of an electrically conductive material, such as steel.

A ball 440 is attached (e.g., welded) to a distal end of the pintle 432. The ball 440 contacts a valve seat 442 and closes a fuel outlet 444 of the fuel injector 204. The ball 440 is made of an electrically conductive material, such as steel.

The solenoid coil 428 generates magnetic flux when current flows through the solenoid coil 428. The magnetic flux moves the pintle 432 vertically upwardly and compresses one or more springs, such as springs 448. The vertically upward movement of the pintle 432 and, therefore the ball 440, opens fuel outlet 444 such that fuel can flow from the fuel inlet 404 through the fuel injector 204 and out of the fuel outlet 444. A solenoid housing 450 surrounds the solenoid coil 428 and is disposed radially outwardly from the solenoid coil 428. The solenoid housing 450 is made of an electrically conductive material, such as steel. The springs 448 urge the pintle 432 vertically downwardly to close the fuel outlet 444.

The pintle 432 is located within a lower housing 452 of the fuel injector 204. The lower housing 452 is made of an electrically conductive material, such as steel. The fuel outlet 444 extends into the engine 102, such as into a cylinder head of the engine 102. One or more O-rings such as 456 may create a seal between the engine 102 and the fuel injector 204.

A sensor 208 (FIGS. 2 and 3) is electrically connected to the fuel injector 204 and measures opening and closing of the fuel injector 204. As shown in FIG. 5, the fuel injector 204 may include a sensor connector 504. Connector pins may be disposed within the sensor connector 504. A first electrical conductor 508 is connected to a flux washer 512, and a second electrical conductor 516 is connected to the solenoid housing 450. The flux washer 512 is made of an electrically conductive material, such as steel. The sensor 208 is electrically connected to the first and second electrical conductors 508 and 516 and measures a voltage across the first and second electrical conductors 508 and 516 or a resistance between the valve seat and the pintle. In various implementations, the sensor connector 504 may be omitted, and the first and second electrical conductors 508 and 516 may be connected within the connector 420 and the sensor 208 can be connected to the first and second electrical conductors 508 and 516 in another suitable manner.

As shown in FIG. 6, the fuel injector 204 includes a guide ring 604 that surrounds the armature 436 and that is disposed between the solenoid housing 450 and the armature 436. A weld ring 608 is disposed between a lower portion of an upper housing 612 of the fuel injector 204 and an upper portion of the solenoid housing 450. The weld ring 608 is made of an electrically insulative material, such as a ceramic, a plastic, or another type of electrical insulator. The upper housing 612 is also made of an electrically insulative material, such as a plastic or another type of electrical insulator. The upper housing 612 may be brazed to the weld ring 608 at joint 616. The eld ring 608 may be brazed to the solenoid housing 450 at 620.

As illustrated in FIG. 6, an outer diameter of the armature 436 may include an electrically insulative coating 624. Additionally, or alternatively, an inner diameter of the guide ring 604 may include an electrically insulative coating 624. The electrically insulative coating may be formed, for example, by vapor deposition or in another suitable manner. The electrically insulative coating 624 may include, for example, a diamond coating, a polymer, one or more nanomaterials, a composite material, a ceramic, or another suitable type of electrically insulative material. The electrically insulative coating 624 electrically isolates the armature 436 from, for example, the electrically conductive solenoid housing 450.

As illustrated in FIG. 7, an outer diameter of the flux washer 512 may include an electrically insulative coating 704. The electrically insulative coating 704 may be formed, for example, by vapor deposition or in another suitable manner. The electrically insulative coating 704 may include, for example, a diamond coating, a polymer, one or more nanomaterials, a composite material, a ceramic, or another suitable type of electrically insulative material. The electrically insulative coating 704 electrically isolates the flux washer 512 (flux ring) from, for example, the electrically conductive solenoid housing 450.

As illustrated in FIG. 8, an outer diameter of the ball 440 may include an electrically insulative coating 804. The electrically insulative coating 804 may be formed, for example, by vapor deposition or in another suitable manner. The electrically insulative coating 804 may include, for example, a diamond coating, a polymer, one or more nanomaterials, a composite material, a ceramic, or another suitable type of electrically insulative material. The electrically insulative coating 804 electrically isolates the ball 440 from, for example, the electrically conductive lower housing 452. The electrically insulative coating 804 may also be highly abrasion resistant as to avoid wear via contact with the valve seat 444. The electrically insulative coating 804 may extend a predetermined number of longitudinal degrees above and below an equator (centerline) of the ball 440.

The sensor 208 may be, for example, a micro electromechanical machines (MEMs) sensor, a Hall Effect sensor, a giant magnetoresistance (GMR) sensor, a piezoelectric sensor, a conductivity based sensor, or another suitable type of sensor.

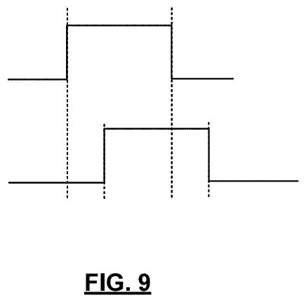

FIG. 9 is an example graph of current compensation based on an opening delay (T_do) of the fuel injector measured using the sensor 208 and a closing delay (T_dc) of the fuel injector measured using the sensor 208. The opening delay corresponds to a period between when current is applied to the fuel injector and when the fuel injector actually opens. The closing delay corresponds to a period between when current through the fuel injector is stopped and when the fuel injector is actually closed with the ball 440 against the valve seat 444. The current control module 308 generates the current command 310 based on the opening delay and the closing delay. This adjusts the amount of fuel that is actually injected by the fuel injector for a fuel injection event toward or to the fuel command 306. For example, the current control module 308 may set the current command 310 based on or equal to an actual open period plus the opening delay minus the closing delay (T_cmd=T_actual+T_do−T_dc). The actual open period is determined by the current control module 308 based on measurements from the sensor 208. For example, the sensor 208 may measure a first voltage when the fuel injector is open and a second voltage when the fuel injector is closed, where the second voltage is different than the first voltage.

In various implementation, predetermined initial parameters (e.g., a predetermined opening delay and a predetermined closing delay) may be stored. The predetermined initial parameters may be obtained, for example, via operation of the fuel injector on a test fixture.

The current control module 308 may adjust the setting of the current command 310 based on measured opening and closing delays as the fuel injector changes over time, such as ages. This allows adaptation of the control of the fuel injector for accuracy. In various implementations, a fault module may be included (e.g., in the fuel injector module) and diagnose a fault in one or more components of the fuel injector (e.g., spring, solenoid coil, gap, ball, etc.) based on the measured opening and/or closing delay. For example, a fault may be diagnosed when the measured opening and/or closing delay is different than the predetermined opening and/or closing delay, respectively, by at least a predetermined amount.

In various implementations, the sensor 208, the current control module 308, the fuel actuator module 124, and the fuel injector 204 may be integrated into a module. In this example, the fuel injector (module) may be referred to as a smart fuel injector.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A valve system of a vehicle, comprising:
a housing that is electrically conductive and made of a metal and that includes:
an inlet configured to receive a fluid;
an outlet configured to output the fluid; and
a fluid channel fluidly connecting the inlet and the outlet;
a pintle disposed within the housing and that is electrically conductive and made of a metal;
a ball that is mechanically fastened to the pintle, that is configured to close the outlet, and that is electrically conductive and made of a metal;
an armature that is mechanically fastened to the pintle, that is disposed within the housing, and that is electrically conductive and made of a metal;
a solenoid coil that is disposed within the housing and that surrounds the pintle; and
an electrically insulative material configured to insulate the pintle from the housing.

2. The valve system of claim 1 further comprising:
a first electrical conductor that is electrically connected to a flux ring; and
a second electrical conductor that is electrically connected to the housing.

3. The valve system of claim 2 further comprising the flux ring, wherein the flux ring is electrically conductive and made of a metal.

4. The valve system of claim 3 wherein the electrically insulative material is disposed on an outer diameter of the flux ring.

5. The valve system of claim 2 further comprising a sensor that is electrically connected to the first and second electrical conductors.

6. The valve system of claim 5 wherein the sensor is configured to measure a voltage across the first and second electrical conductors.

7. The valve system of claim 5 wherein the sensor is configured to measure a resistance between the pintle and the housing.

8. The valve system of claim 1 wherein the electrically insulative material is disposed on an outer portion of the ball.

9. The valve system of claim 8 wherein the electrically insulative material is disposed a predetermined distance above and below an equator of the ball.

10. The valve system of claim 1 wherein the electrically insulative material is disposed on an outer diameter of the armature.

11. The valve system of claim 10 further comprising a guide ring that is disposed radially outwardly of the armature.

12. The valve system of claim 1 wherein the electrically insulative material is disposed on an inner diameter of a guide ring that is disposed radially outwardly of the armature.

13. The valve system of claim 12 further comprising the guide ring.

14. The valve system of claim 12 further comprising a weld ring that is electrically insulative and that is disposed radially outwardly of the guide ring.

15. The valve system of claim 14 wherein:
the housing includes a first housing portion and a second housing portion; and
the weld ring is disposed vertically between the first housing portion and the second housing portion.

16. The valve system of claim 15 further comprising:
a first brazed joint where the first housing portion contacts the weld ring; and
a second brazed joint where the second housing portion contacts the weld ring.

17. The valve system of claim 1 wherein the valve system is a fuel injector system and the outlet is configured to extend into an engine of the vehicle.

18. The valve system of claim 17 wherein the outlet extends into a cylinder of the engine.

19. The valve system of claim 1 wherein the metal is a stainless steel.

20. The valve system of claim 1 wherein the electrically insulative material includes one of diamond, a polymer, a nanomaterial, a ceramic, and a composite material.
